(19) United States
(12) Patent Application Publication
(10) Pub. No.: US 2006/0009960 A1
(43) Pub. Date: Jan. 12, 2006

(54) System and method for managing data tables

(75) Inventors: Patrice Valencot, Miribel (FR); Patrick Potteau, Lys Lez Lannoy (FR); Gilbert Magri, Plaisir (FR); Jacques Potier, Saran (FR); Jean-Christophe Perrin, Paris (FR); Dominique Mera, Lyon (FR)

Correspondence Address: COHEN, PONTANI, LIBERMAN & PAVANE, Suite 1210, 551 Fifth Avenue, New York, NY, 10176, US

(73) Assignee: France Telecom, Paris (FR)

(21) Appl. No.: 11/125,695

(22) Filed: May 10, 2005

(30) Foreign Application Priority Data
May 10, 2004 (EP) 04291197.4

(51) Int. Cl. G06F 9/45

(52) U.S. Cl. 703/22

(57) ABSTRACT

A system and a method for managing a set of data tables stored in at least one database (15). The system (10) includes at least one constructor device (11) configured to create at least one dated link in order to establish a relationship between at least two of said data tables according to at least one date and configured to create at least one dated rule in order to check the validity of said dated link. The system includes at least one data administrator device (12) capable of checking the compatibility of at least one of said data tables with at least one of said dated links and one of said dated rules, and also includes at least one history manager device (24) capable of saving after said check of said dated link and said dated rule in said database (15).

### FIELD OF THE INVENTION

The present invention relates to a system and a method for managing a set of data tables.

The invention applies more particularly for the management of the validity of the data from said tables and for the validity of the dating of links between said data tables.

### BACKGROUND OF THE INVENTION

Currently, the databases enable a data model to be described and management rules to be created for the data present in said database. The description of the data model corresponds, for all of the data tables of the database, to the definition of tables and links existing between the various data tables. In current databases, the data management rules only enable the properties allocated to the data, as well as the cross references, to be verified. The properties of a data are the characteristics specific to said data, such as the format, the size, etc, of said data. A cross-reference enables the identity of a second data table with which the first table is linked to be identified in a first data table. The possible management in the existing databases is, consequently, very limited.

Moreover, the existing products from the management of data tables use said database functions, by proposing simple data updating procedures, with the aid of data entry forms without check of the validity of said data.

When said management products are used by a plurality of users, the latter may independently execute various updates on the data. Consequently, said products may not guarantee at any moment the consistency of the data between same.

In addition, said products do not enable parameters specific to the user to be taken into account, function of the field of activity of said users of data tables, for example a data validity duration.

### SUMMARY OF THE INVENTION

One object of the present invention is to provide a system and a method for managing a set of data tables, stored in at least one database, which would enable the disadvantages of the existing systems to be remedied by avoiding the lack of consistency of said data and the lack of synchronisation of the data between the various users.

This and other objects are attained in accordance with one aspect of the present invention directed to a system for managing a set of data tables stored in at least one database. The system includes at least one constructor device configured to create at least one dated link in order to establish a relationship between at least two of said data tables according to at least one date and configured to create at least one dated rule in order to check the validity of said dated link, includes at least one data administrator device capable of checking the compatibility of at least one of said data tables with at least one of said dated links and one of said dated rules and includes at least one history manager device capable of saving after said check said dated link and said dated rule in said database.

Another aspect of the present invention is directed to a method for managing a set of data tables, stored in at least one database. The method comprises the steps of creating in at least one constructor device at least one dated link in order to establish a relationship between at least two said data tables according to at least one date; creating in said constructor device at least one dated rule in order to check the validity of said dated link; checking in at least one data administrator the compatibility of at least one of said data tables with at least one of said dated links and one of said dated rules and after said check, saving by at least one history manager device said dated link and said dated rule in said database.

Thus, said management system and method, in accordance with one embodiment of the invention, guarantee the consistency of the data via the application of dated rules relating to said data tables. A constructor device establishes at least one relationship between the various data tables, by creating a dated link between two data tables. Then, a data administrator device verifies that said dated link and said dated rule are compatible with said management system and that said related data tables are in accordance with the dated links and dated rules, which have been created. Finally, a history manager device saves all of the elements of said management system.

According to an embodiment of the invention, said dated rule comprises at least one condition to implement, separately or in combination, via said dated links, via said data tables.

According to an embodiment of the invention, said dated link and said dated rule, separately or in combination, comprise at least one characteristic relating to a validity date.

According to an embodiment of the invention, said data link describes at least one link with a direction defined by at least one source data table and at least one target data table in order to hierarchise said data tables.

According to an embodiment of the invention, in a dated link, said target data table is modified in relation to said source data table by said constructor device.

A dated rule defines at least one constraint between two data tables with the aid of conditions to be implemented, separately or in combination, via said dated links or via said data tables. In particular, said constraints take account of the hierarchisation of said data tables, as well as the validity dates.

A dated link and a dated rule enable the creation of a period of validity by allocating at least one validity date to said related data, to said link or to said rule created. Each element of said management system or each relationship between said elements has a period of validity. Said dating enables time management of the upgrades in said management system.

A dated link may establish a hierarchical relationship between the data tables. The direction of said dated link classifies said data tables in different levels. With the aid of said dated links, the data tables in the database are organised in higher and lower levels from the highest to the lowest level. In this way, any action on a first data table corresponds to an action on a second data table, when said second table is linked with the first by at least one dated link. The constructor device enables the direction of the dated links to be created and modified.

In accordance with an embodiment of the invention, said data administrator device automatically checks at least one modification, separately or in combination, of one of said data tables, of one of said dated links according to said dated links.

The creation of dated links and rules, validity dates and conditions to be implemented enable the creation of a dated link with a period of validity between the various data tables. In this way, said data table management system, in accordance with the invention, enables data tables of the database to be checked at any moment by enabling the automatic management of the consistency of the data during a modification.

At the time of a modification, the latter is carried out according to the existing dated links and rules and taking account of the period of validity of said links and rules. If necessary, said validity dates are updated during a modification.

According to an embodiment of the invention, said data administrator device is configured to command at least one history manager device capable of storage, separately or in combination, one of said data tables, one of said dated links.

According to an embodiment of the invention, at least one history manager device automatically commands the storage of at least one modification with a creation date of said modification.

According to an embodiment of the invention, said history manager device commands at least one storage of each of said dated modifications.

All of the elements of said management system are automatically saved in the database, as well as any modification on one of the elements of said management system. In this way, the consistency of the data tables is preserved and any lack of synchronisation between said data tables is avoided.

Whoever the user who accesses the management system, the data tables are in accordance with the last update. The various updates, creations, deletions, modifications, etc., carried out in said management system, are saved with the creation date. Consequently, at any moment, said management system can be checked by the authorised users by keeping a dated trace of the various actions. A storage of the various updates enables the past status of said management system to be known, with the various dated upgrades.

According to an embodiment of the invention, at least one rules manager automatically checks the conformity of said dated rules according to said dated links.

According to an embodiment of the invention, said conformity check of said dated rules is centralized only in said rules manager.

According to an embodiment of the invention, at least one constraints manager automatically checks the implementation of at least one condition of said dated rules according to said dated links.

According to an embodiment of the invention, at least one error is transmitted towards at least one user by said rules manager after said checks.

During a modification, that is a creation or a deletion or a change of element of said management system, the management of the consistency between said data tables is carried out centrally by a rules manager, unique in said management system, which checks the conformity of the dated rules and the implementation of said dated rules by taking account of the links existing between the data tables.

Then, at least one constraints manager checks the implementation of the conditions of said dated rules. Once again, said implementation is carried out by taking account of the existing links between the data tables.

In the case of negative checks, a list of errors is transmitted towards the users of said management system.

According to an embodiment of the invention, said management system includes at least one import device capable of importing data towards said database.

According to an embodiment of the invention, said management system includes at least one export device capable of exporting data from said database.

Upgrades permitting, new data tables may be imported in the database towards said management system. Likewise, for example after a modification, data tables may be exported from said database.

In accordance with an embodiment the invention, said data administrator device is configured to command at least one rights manager capable of checking at least one right of a user of said management system.

In accordance with an embodiment of the invention, at least one rights manager modifies at least one right of a user of said management system.

The various users of the data table management system may have different rights. Some users may only consult the data tables. Other users are authorised to modify the data. Others again may create, import or export data tables.

In accordance with an embodiment of the invention, said data administrator device is configured to command at least one task manager capable of managing at least one modification, separately or in combination, of one of said data tables, of one of said dated links.

In accordance with an embodiment of the invention, at least one task manager commands the prohibition of access to said data tables during the duration of a modification.

A plurality of users may carry out a modification, or a creation or a deletion or change an element, for example the updating of a validity date. In order to maintain the consistency at any moment in the database, during said modification by a first user, a task manager may prohibit any other modification for a second user. In addition, said task manager checks the actions of the various users according to the rights of each one.

In accordance with an embodiment of the invention, said constructor device is configurable in order to automatically modify, separately or in combination, said, said data administrator device, said rights manager, said task manager, said rules manager, said constraints manager, said status manager, said history manager device, at least one import device, at least one export device.

The data table management system enables upgrades according to the requirements of the users. It is envisaged for an operation, whatever the data table, the links, the rules, the dates, the conditions, the field of activity of the users, etc. It is adapted to each operation according to the parameters saved with no direct modification of said management system.

The constructor device enables the data tables, the links tables, the various links present, the rules, the rights of the users to be upgraded. The data administrator device enables the automatic adaptation of said management system to the upgrades created from said constructor device, without modification of the management system itself.

### BRIEF DESCRIPTION OF THE DRAWINGS

FIG. 1 represents the general architecture of a system for managing a set of data tables, in accordance with an embodiment of the invention.

FIG. 2 is a diagram representing the links between the data tables of said management system.

FIG. 3 represents the information exchanges in said data table management system.

FIG. 4 is a representation of the steps of said method for managing a set of data tables, in accordance with an embodiment of the invention, during a creation.

FIG. 5 is a representation of the steps of a management method of a set of data tables during a modification.

### DETAILED DESCRIPTION OF THE DRAWINGS

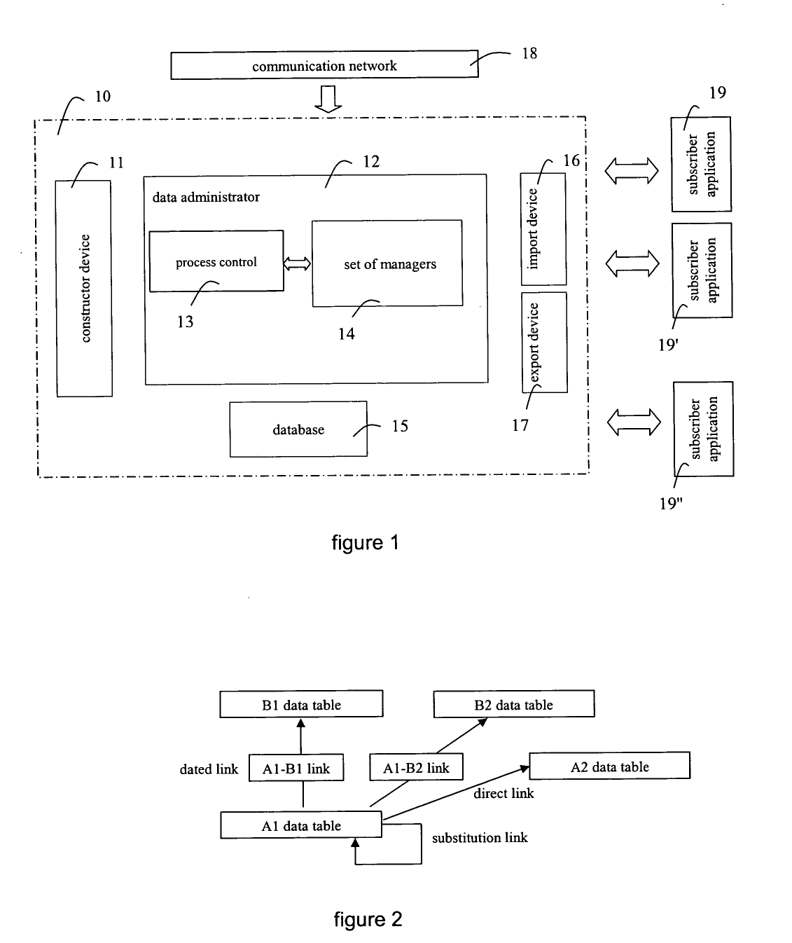

A system 10 for managing data tables, in accordance with the invention, includes at least one constructor device 11 and at least one data administrator device 12. It may also include at least one import device 16 and at least one export device 17. Said system 10 for managing data tables, represented in FIG. 1, enables a stored set of data tables to be managed in at least one database 15. Said database 15 may physically be included or not to said data table management system 10.

Said data may be of any type. Said database 15 may be used in various fields of activity, for example, a catalogue of products with the list of spare parts corresponding to said products, the quantities in stock, etc.; a directory of agencies of a company with the list of addresses, employees, opening times, etc.; a system of references of accounts of a company with the organisation of said company, the profit and loss centres, the geographical areas; etc. The various users of the management system wish to use and modify the data stored in at least one database 15, by maintaining the consistency of said data whatever the upgrades carried out.

The users are connected to said data table management system 10 via a communication network 18 of a different type according to the field of activity of said user, for example an intranet network in a company or even the Internet network via an existing browser.

As shown in FIG. 2, links exist between the various data tables in order to establish one or more relationships between said tables. Said links may be of different types. A link is called direct link when it establishes a direct relationship between two different data tables (link between A1 and A2 data tables). A link is called substitution link, when it indicates the substitution of an element of an A1 table by another element from the same A1 data table.

In addition to said direct or substitution links, said data table management system 10, according to the invention, includes at least one constructor device 11, which enables the creation of at least one dated link in order to establish a relationship between said data tables according to at least one date, as well as the creation of at least one dated rule in order to check the validity of said dated link.

Said management system 10 includes said constructor device 11 configured to create at least one dated link in order to establish a relationship between at least two data tables according to at least one date and configured to create at least one dated rule in order to check the validity of said dated link.

Said management system 10 also includes a data administrator device 12 capable of checking the compatibility of at least one of said data tables with at least one of said dated links and one of said dated rules.

The dated link describes a link with a direction defined by a source data table and at least one target data table in order to hierarchise said data tables.

Said A1-B1 dated link establishes a relationship, the direction of which is defined with the aid of an A1 source table called “son” and a B1 target table called “father”. A father may have a plurality of sons (A1-B2 link) and a son may have a plurality of fathers. Consequently, a data table may be linked to a plurality of other data tables (A-B1 and A1-B2 links). In this way, all of the data tables are hierarchised with lower and upper levels.

In addition, said dated links and said dated rules may comprise at least one characteristic relating to a validity date, in particular a validity start date (or VSD) and a validity end date (or VED). Said VSD and VED dates define the period of validity of the data.

Said dated links may, for example, be organised and saved in one or more tables of links.

A dated rule enables constraints to be defined between at least two data tables. Said dated rule comprises at least one condition to implement, separately or in combination, via said dated links, via said data tables. A dated rule may for example contain the following conditions at least: the period of validity of a son must be included in the period of validity of a father; the period of validity of a link must be included in the period of validity of the father and the son. As the rules are dated, a new rule applicable to the date defined simply needs to be created in order to change the rule. In order to facilitate the creations and upgrades of the system, it is possible to automatically reproduce a rule existing in another data table.

Said management system 10 verifies the consistency between the various rules. Generally, in order to maintain the consistency, the dated links between the various tables must be consistent with the dates of the father element and the dates of the son element. In addition, the creation of certain elements of a table may result in the creation of elements from other tables or even the creation of links. Any modification, that is a creation or a deletion or a change of element of said management system, is carried out by successive step following the order of the hierarchical levels. The data tables in the database are organised in upper and lower levels, from the highest to the lowest. In this way, any action on a first data table corresponds to an action on at least a second data table, when said second table is linked with the first via at least one dated link.

In addition, the characteristics of the element must have a format compatible with said management system, such as the format, size, etc., of said element.

Said constructor device 11 enables the description of the data “model” to be upgraded. Said data “model” is made up of various elements, that is, for all of the data tables, the definition of the dated or non-dated tables, the various links present (direct link, substitution link or dated link) and the associated management rules, as well as the definition of the existing security clearances. Said “model” is saved in the database 15, which enables a modification of each of the elements of said “models”.

For the same data tables, a plurality of “models” may be created and saved, for example during the use of said data tables by a plurality of companies. In this case, the management is multi-companies and may be different according to the companies for the same management system. The data from various tables may also be in a plurality of languages.

Said “model” defined by the constructor device 11 may be modified during a re-allocation in order to reorganiser the existing links. The direction defined in the dated links may be modified, where the modification of the “father” for a “son”, for example when an existing agency formerly attached to an X centre is attached to a Y centre. The existing relationships between the data tables may be modified, for example, the father may be modified for a given son. In a dated link, said target data table is modified in relation to said source data table by said constructor device 11.

Said data administrator device 12 enables said management system 10 to be adapted, according to the invention, to the data “model” upgrades, without having to modify said management system 10 directly. Said data administrator device 12 automatically checks any modification, separately or in combination, of one of said data tables or of one of said dated links according to said dated links. Said adaptation to the upgrades is automatic with the aid of a set of managers 14. The functionalities of the set of managers 14 are envisaged in order to adapt and configure said data table management system 10, according to the requirements of the users. Each function is carried out by a manager, which brings a high degree of adaptability for a very flexible and dynamic management of said data table management system. The various managers 14 may be physically included or not to said data administrator device 12.

The rights of each of the users, prior to any action on an element of said management system 10 (data, tables, etc.), are verified by at least one rights manager. Said data administrator device 12 is configured to command at least one rights manager capable of checking at least one right of a user of said management system 10. Said rights manager modifies a right of a user of said management system 10. The rights may, for example, take account of the hierarchical level of the element from the database 15, upper or lower level. The users may access or modify according to said rights. According to the rights, from a given element, said user accesses or modifies the elements which are hierarchically lower in the database 15.

The consistency of the actions between the various equipment of said management system 10 is assured by at least one task manager. Said data administrator device 12 is configured to command at least one task manager capable of managing at least one modification, separately or in combination, of one of said data tables or of one of said dated links. Said task manager identifies and blocks the access to the elements of said system in the process of being modified, in order to prevent concomitant accesses. Said task manager commands the prohibition of access to said data tables during the duration of a modification.

The verification of the consistency of the data is carried out by at least one rules manager 21. Said data administrator device 12 is configured to command at least one rules manager 21 capable of checking the conformity of said table of rules. Said rules manager 21 automatically checks the conformity of said dated rules according to said dated links.

Making the data consistent with the aid of the rules is managed by a process control 13 (or workflow), commanded by at least one constraints manager 22. Said constraints manager 22 prevents the persistence of inconsistencies and commands the lifting of said inconsistencies. Said data administrator device 12 is configured to command at least one constraints manager 22 capable of checking the implementation of at least one condition from a dated rule. Said constraints manager 22 automatically checks the implementation of at least one condition of said dated rules according to said dated links.

The making available of data is managed by at least one status manager 23, which enables data to be used by a plurality of users. Said status manager 23 automatically creates a status for each of the elements according to the inconsistencies corresponding to said elements of the management system 10. Said data administrator device 12 is configured to command at least one status manager 23 capable of authorising the making available, separately or in combination, of one of said data tables or of one of said dated links. Said status manager 23 automatically creates a status to authorise the making available, separately or in combination, of one of said data tables or of one of said dated links. Said status is validated and making available is authorised only when all of the conditions of at least one dated rule are implemeted. According to the parameters, the status may be modifiable or non-modifiable.

Said history manager device 24 stores in particular, all of the modifications carried out, as well as all of the existing relationships between the various elements of said management system. Said data administrator device 12 is configured to command at least one history manager device 24 capable of storage, separately or in combination, one of said data tables or one of said dated links. Said history manager device 24 automatically commands the storage of at least one modification with a creation date of said modification. The various statuses of the “model” are archived in said history manager device 24 with the corresponding dates. At any moment, a check may be carried out by an authorised user, who retrieves the existing status at a given date.

Said data administrator device 12 enables either a single element of said management system, or a plurality or all of the dated or non-dated elements to be updated. Generally, it carries out a permanent check of the validity of said elements and of their consistency with the aid of various managers. It also includes said process control 13 (or workflow), which manages the actions of the users in order to correct the inconsistencies. Finally, it validates the modifications and deletes the access blockages to the elements in process of being modified.

Said data administrator device 12 thus carries out the final validation of said modifications by authorising the modifications once all of the rules are validated. In this case, the storage of said modification is therefore possible, as well as the unblocking of the prohibition of access to said data.

All of the elements are saved in the database 15, as well as all of the modifications carried out by maintaining a dated trace of the various actions. Said history manager device 24 is capable of saving after said checks, in particular, said dated links and said dated rules in the database 15.

In this way, the consistency of the data tables is preserved and any lack of synchronisation between said data tables is avoided. Whoever the user who accesses the management system, the data tables are in accordance with the last update. The various updates, creations, deletions, modifications, etc., carried out in said management system, are saved with the creation date. Consequently, at any moment, said management system can be checked by the authorised users by maintaining a dated trace of the various actions. A storage of the various updates enables the past status of said management system to be known, with the various dated upgrades. Said history manager device 24 commands the storage of each of said dated modifications.

Said import device 16 enables data to be imported towards said management system 10, for example, originating from other external databases of said management system 10. Said management system 10 may include an import device 16 capable of importing data towards the database 15. Said export device 17 enables the diffusion of data from said management system, in particular towards the subscriber applications 19, 19′, 19″. Said management system 10 may also include an export device 17 capable of exporting data from said database 15.

The subscriber applications 19, 19′, 19″ use the data managed by said management system 10. These are generally planning applications of company resources (or ERP, Enterprise Resource Planning). For example, according to the field of activity of the users, the stock list of spare parts of a product or the list of agencies of a company or even in the accounts data management in a company, etc.

The system and method for managing data tables include a set of parameters, enabling in particular the description of the data “model” as well as the consistency of the rules to be upgraded. The normal rules for a usage, corresponding for example to the fields of activity defined, are pre-existing and may be activated in said management system 10. “Common sense” rules are also automatically predefined, such that the validity end date is superior to the validity start date. The rights or fields of security clearance and may also be predefined according to the usual profiles of the users, corresponding to professions from the field of activity of said users. It is also possible to configure the initialisation and the export of data towards the various subscriber applications 19, 19′, 19″, users of data.

In said management system 10, the constructor device 11 is configurable in order to automatically modify, separately or in combination, said data administrator device 12, said rights manager, said task manager, said rules manager 21, said constraints manager 22, said status manager 23, said history manager device 24, at least one import device 16, at least one export device 17. In this way, the authorised users may also adapt the management of the data managed by said management system according to each customer company. With the predefined rules, profiles and users, said management system 10 is configurable according to the field of activity without any direct modification of said management system 10.

The flexibility of said management system is carried out with the aid of the processing of rules via the rules manager 21, which are saved in said database 15.

Said management system 10 enables a flexible management of the data with the aid of the modification of the structure of the data “model” or the addition of new data tables, without any direct modification of said management system. The data table management system 10 enables upgrades according to the requirements of the users. It is envisaged for an operation whatever the data table, the links, the rules, the dates, the conditions, the profession of the users, etc. It is adapted to each operation according to the parameters saved, without any direct modification of said management system.

As previously mentioned, the data “model” is made up of various elements, that is said data tables or said dated or non-dated links, said associated management rules, links between said elements, the definition of existing rights, etc. Said “model” is saved in the database 15, which enables each of the elements of said “model” to be modified.

So as to make it possible to configure all of the elements of said data “model”, the management system 10 is envisaged for any type of operation, whatever the existing data table, the links, the rules, the dates, the users, the subscriber applications, etc. Said management system 10 thus generally and generically contains all of the basic functions. Then, it is adapted to each operation according to the configuration carried out and saved in at least one database, without any modification of said management system. Likewise, said system 10 can be adapted to any upgrade during operation and the configuration initially envisaged enables all of the modifications of the various elements of the data “model”, which are again saved in at least one database 15.

In particular, the generation of the display screens is dynamic and adapted according to the existing configuration. It is upgradeable taking into account the modifications carried out. Consequently, a modification automatically generates at least one change for the display, separately or in combination, of one of said data tables, of one of said table of links. For example, the display screens enable the display of the list of attributes of an element, whilst respecting the characteristics defined in the data “model”, the size of the fields, the order, etc.

Said constructor device 11, which enables the description of the data “model” to be upgraded, as well as the import 16 and export 17 devices, facilitates the flexible and dynamic management of the data.

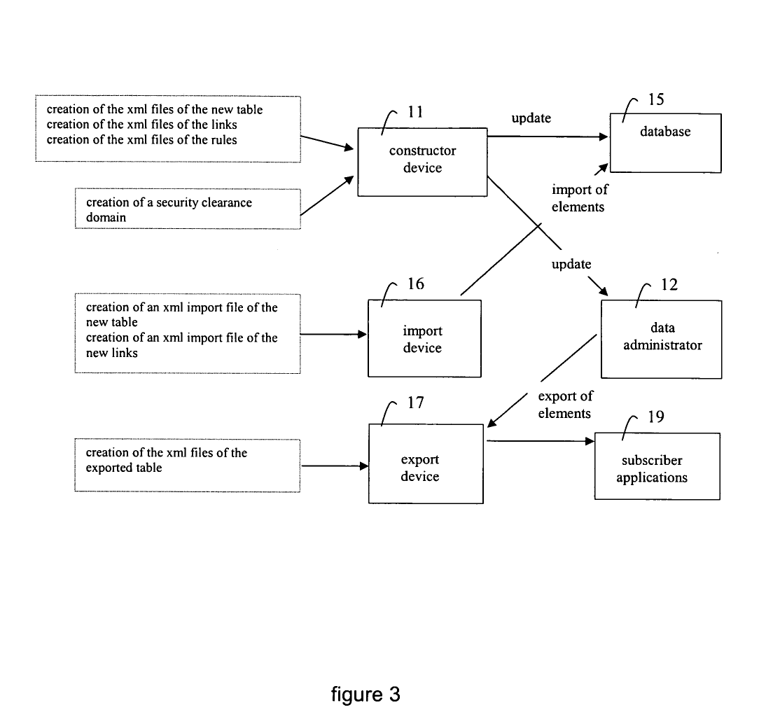

The description of said “model” may be modified in said management system 10 in accordance with the invention, as shown in FIG. 3, with the information exchanges in said management system 10.

A modification may correspond to the addition or the deletion of a product in the catalogue or even the creation or the closing of an agency of the company, etc. according to the field of activities of the users.

A modification of said “model” is described generally with the aid of an XML format file (that is Extensible Markup Language, upgraded html language enabling the customisation of tags or markups), usually used for the description of data or any other equivalent data description formats. Said XML format file enables the data table or a link or even a rule to be created, modified or deleted. Said constructor device 11 verifies the validity of said file received, converts the commands defined in said XML file in the form of one or more modifications to be carried out by said management system 10 and saved in the database, then validates said modification of the database. Said management system 10, completely configurable, will directly and automatically generate the corresponding modifications for the acknowledgement in the operation of said management system 10.

Said import device 16 enables said recently created data table to be supplied. A second file, in particular, in XML format, received by the import device 16, enables data from the new table to be imported. Said second XML file describes the text file structure containing the data to be imported. The import device 16 calls on the rules manager 21 of said data administrator device 12 in order to verify that the imported data is compatible with the rules of said management system 10. If this is not the case, said table is not created in the database and a list of errors of abnormal elements is generated by the table management system 10. Said management system 10 transmits at least one error towards at least one user by said rules manager 21 of said data tables.

Said export device 17 enables the data to be transmitted towards the subscriber applications 19, 19′, 19″, outside of said table management system 10. The data transmission format, as well as the transmission frequency, are also defined in a third file, in particular in XML format. The export device 17 supplies, for example, either a file containing all of the data to be exported, or only the data created or modified since the previous export, or only the data created or modified between two dates.

To assist the understanding of the invention, the various steps of a method for managing a set of data tables, in accordance with the invention, are currently specified.

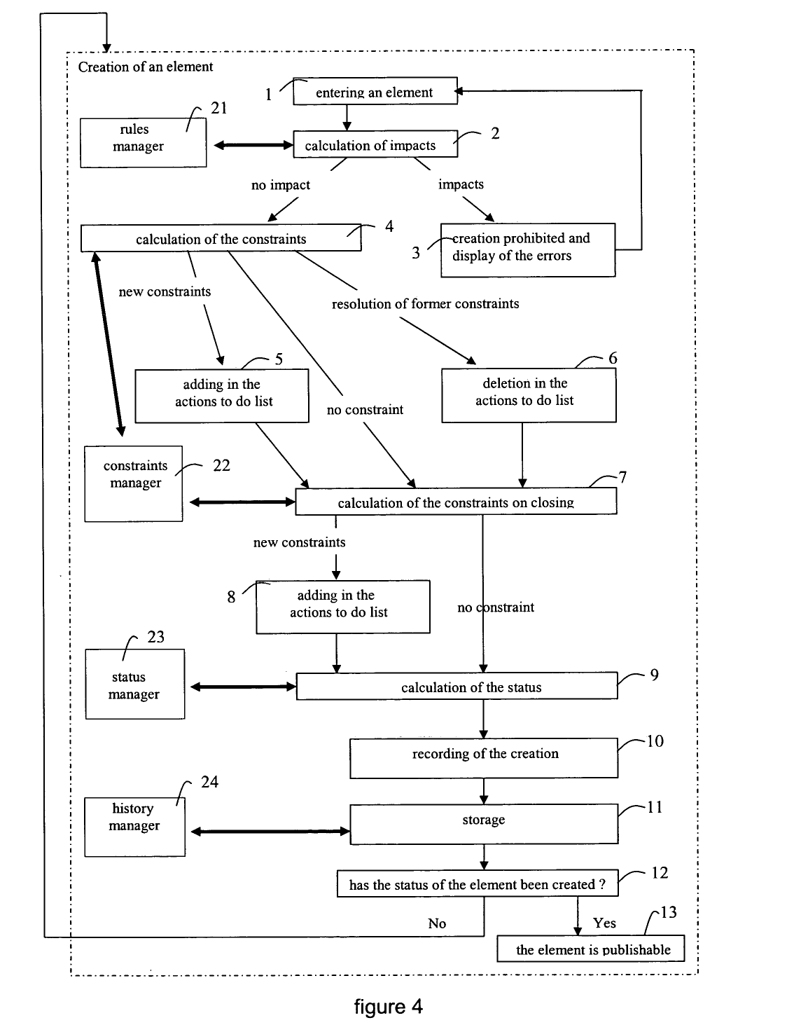

By way of example of an action carried out on said management system 10, the main steps implemented during a creation by a method for managing data tables, in accordance with the invention, are represented by FIG. 4.

Once the “model” defined by the constructor device 11, an authorised user may carry out a creation requests for any element of said management system. Said creation request may relate to any element, as well as any element of a data table, the new dated or non-dated link between said tables, etc., for which the creation procedure is similar, and called “an element” in order to simplify the description.

Said user logs on to the management system 10 for example via a company local private network or any other communication network 18 enabling the transmission of data (Internet or IP or ATM or other network).

An element creation is a recursive procedure, which may be repeated an indeterminate number of times by activation of the same procedure, that is said creation may command the creation of other elements of lower hierarchical levels, able themselves to command the creation of additional elements and so on. When it has been possible to create the elements from the lowest levels, the creation of other elements may be carried out by successively going up the existing hierarchical levels in the database.

In order to simplify FIG. 4, the rights manager is not mentioned. However, at least one user may act on at least one element of said management system 10 only if the latter is a user authorised for said action on said element.

The various users of the data table management system may have different rights. Some users may only consult the data tables. Other users are authorised to modify the data. Others again may create, import or export data tables. Consequently, there are various security clearance levels which are configurable via the authorisations manager.

For the creation of an element in a data table by a user, the various attributes of said element to be created are entered whilst respecting the size, the format, etc., of the data (step 1).

When the data tables are imported into the database, the creation procedure is similar to the creation requests carried out by a user, so as to create relationships via the table of links, the hierarchisation in said database 15 and the table of rules, corresponding to said imported data tables.

The rules manager 21 calculates the impacts and verifies if the existing rules in said management system are or are not respected (step 2). When the existing rules are not respected, the creation is stopped and prohibited. A display of the errors, carried out during the creation, is transmitted towards the user (step 3). At least one error is transmitted towards at least one user by said rules manager 21 after said checks.

When the existing rules are respected, the constraints manager 22 creates at least one constraint corresponding to said element in the process of being created (step 4). The constraints are the conditions to be implemented, indicated in the rules, according to the validity dates and the hierarchisation of the database 15. The constraints are added into an actions to do list (step 5).

Generally, the actions to do list is the description of the linking of actions to implement and the indication of the author of said actions. The actions may also be a creation like any modification of any element or link or even a deletion of an element or link, etc.

The constraints manager 22 creates as many constraints as non-respected rules. Said created constraints are added and saved in the actions to do list corresponding to said creation.

The creation of said element may create no constraints corresponding to said element in the process of being created or even enable the resolution of existing constraints for other elements (step 6). Consequently, the resolved former constraints are once again automatically deleted from the actions to do list.

Said constraints manager 22 also verifies the new constraint(s) created and resolved which may be closed (step 7), in the case of the creation of an element linked with a main element of a closing request, as previously described. The closing of certain constraints may create new constraints to be added in the lists to be carried out (step 8). The actions to do list is saved in the database 15.

Said rules manager 21 automatically checks the conformity of the dated rules according to the existing links. Said constraints manager 22 automatically checks the implementation of at least one of the conditions of said dated rules according to the existing links. Said constraints manager 22 verifies the constraint(s) in creation, which are resolved during the creation of said element. When a constraint is resolved, the latter is deleted from the actions to do list for said creation.

In order to resolve a created constraint, it is necessary to make disappear an element in an actions to do list. As previously mentioned, a creation request for a main elements may command other creation requests on elements of lower hierarchical level in the database. All of the constraints must be resolved in order to empty the actions to do list corresponding to said main elements to be created. As many creation requests of an element as necessary are thus carried out until said actions to do list is empty.

When all of the constraints created or generated by the same creation request are resolved, said request is valid because the actions to do list is empty. The creation request may thus be validated and the main element, that the user wishes to create, is effectively created. Said creation is saved in the database 15 by said history manager device 24.

Once the constraints and the lists to be carried out managed, the status manager 23 creates the status corresponding to said element in the process of being created (step 9). Said status is validated when all of the constraints in creation are resolved. Otherwise, the status is invalid. The status of the element(s), linked to said element in the process of being created, is also validated when all of the constraints corresponding to all of the linked elements are resolved.

The creation of an element is recorded when the status is created (step 10).

All of the modifications, addition or deletion in at least one actions to do list are saved in the database 15 by said history manager device 24, as well as the status and associated links (step 11).

The creation of a new element generally commands one or more creation requests for another element or even for a new link. Each new creation request modifies at least one actions to do list, by creating at least one constraint corresponding to said creation request. Each element effectively created deletes generally at least one constraint in at least one actions to do list for said creation of an element. In any event, the status of all of the elements, linked to said element in the process of being created, is only validated when all of the constraints are resolved. Without status, said element may not be publishable (step 12). When the status is validated, said created element is publishable, that is it may be made available (steps 13). Making an element from the management system 10 available enables either the access of said element via the subscriber applications 19, 19′, 19″, or the export of said element.

A rule may be defined as mandatory or optional. If the rule is mandatory, the constraints must mandatorily be resolved prior to deletion in the actions to do list. Conversely, it is possible to not take account of an optional rule for the creation of the corresponding element.

With the existing status, the element is created and saved in said database 15 by the history manager device 24 with said existing links. After said check, the history manager device 24 saves said elements, for example the dated link, in the database 15.

Said history manager device 24, which makes the data available towards the subscriber applications 19, 19′, 19″ to set management system, also saves the status of said created element. When said status is validated, said created element may be exported towards said external subscriber applications 19, 19′, 19″. Otherwise, said element cannot be exported, and can only be used in said database 15.

Similarly, the main steps of the method for managing tables are identical in the case of modification of an element or of an existing link in the database 15, as well as in the case of the deletion of an element or a link. In order to simplify the description, generally, all of said actions are called a modification.

The method for managing data table guarantees the consistency during any modification, with the aid of the rules manager 21. Said rules manager 21 is called on by said data administrator device 12 and by said import device 16. As previously mentioned, with the aid of the dated links and rules, each element existing in the database 15 is characterised by a period of validity.

Each one of the rules is represented by a code and said code is allocated to each of the data tables for which said rule applies. Said existing rules and said codes are saved in the database 15. Consequently, it is possible to configure each of the rules for each data table or to deactivate at least one rule for a particular data table. It is also possible to add a new code, that is to modify the “model”, without directly modifying said table management system with the aid of said configuration.

The verification of the rules is only carried out by the rules manager 21, which centralizes this function. The conformity check of the dated rules is centralized only in said rules manager 21. When said rules manager verifies the consistency of a creation or of a modification of an element from the database, said element becomes publishable. According to the action in the process of being carried out, the rules, corresponding to said action, the context of the action (creation, modification, etc.), etc. are verified. After verification, in the event of a problem, a list of errors is transmitted towards the user. At least one error is transmitted towards at least one user by said rules manager after said conformity check. Said errors may be blocking areas, which stop the procedure in process, or even simple warnings.

Said rules manager 21 centralizes the verification of the rules, whatever the action in process. The constraints manager 22 calls on same as soon as an update is necessary, for example for an actions to do list during a closing. In the event of an error, said constraints manager 22 creates the constraints corresponding to said errors detected by the rules manager 21. Said status manager 23 calls on the constraints manager 22 in order to know the number of constraints in creation corresponding to said related element by the action. During the creation of an element, said rules manager 21 commands the stop of the procedure in process if a blocking error is detected.

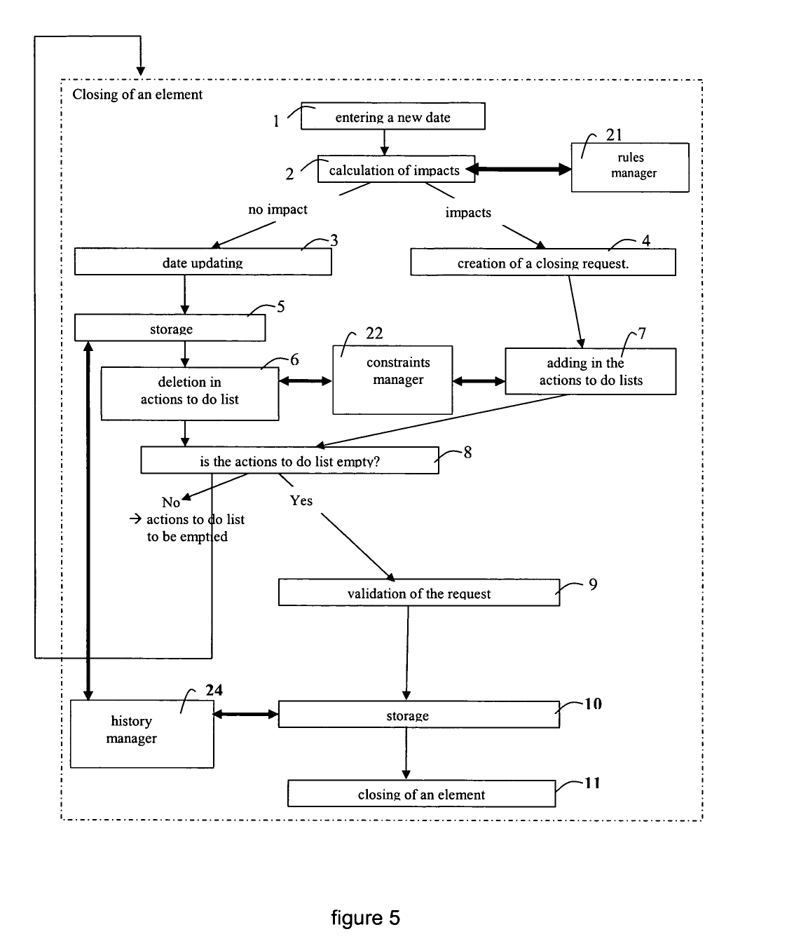

By way of additional example to that previously described, the main steps implemented by a method in accordance with the invention, during at least one modification request are represented by FIG. 5.

The modification relates to a validity end date (VED) of an element (called “closing”), in order to verify the consistency of the dates between the linked elements and making consistent of said dates following the modification. The management of the consistency is very important during a “closing” and enables an adaptable system, which remains homogenous, whatever the modifications and the different users. A plurality of authorised users may work in cooperation and, for example, be responsible for updates on the various functions.

A modification may be carried out on any element of said data table management system, including the deletion of said element.

In the same way as for the creation procedure, recursively, a closing may be repeated, an indeterminate number of times by the activation of the same procedure, that is said closing may create the inconsistencies requiring the closing of other elements of lower level of the hierarchy and so on. When it has not been possible to modify the elements of lower level of the hierarchy, the user may then carry out the closing of elements by successively going up the existing hierarchical levels in the database.

When the user modifies at least one validity end date (VED) of an element, a date modification request is transmitted during the closing procedure of said element. A new date is entered (step 1).

Said rules manager 21 is called on and calculates the impacts in order to determine if the management of the rule(s) relating to said elements are always verified in the case where the requested modification would be carried out (step 2). If there is no inconsistency in relation to the existing rules, the modification of the date is carried out and stored in the database 15 (step 3). The modification of said date is saved by said history manager device 24 (step 4). If the date modification resolves in particular a constraint, the latter is deleted in the actions to do list during the closing (step 5). Said actions to do list is itself saved in the database 15.

Conversely, if at least one rule is not respected, the user may create a closing request on said element that he wishes to modify, called main element (step 6). The constraints manager 22 creates as many constraints as non-respected rules. Said created constraints are added and saved in the actions to do list during the closing (step 7).

In order to resolve a created constraints, and thus to make disappear an element in the actions to do list during a closing, a user must carry out the closing of said element. As previously mentioned, a closing request for a main element may command the creation of other closing requests on elements of lower level of hierarchy in the database. All of the closing requests must be carried out from the lower levels of the hierarchy. All of the constraints must be resolved in order to empty the actions to do list corresponding to said main elements to be modified. As many closing requests of an element as necessary are thus carried out until said actions to do list is empty.

When all of the constraints created or generated by the same closing request are resolved, said modification requests is valid because the actions to do list is empty (step 8). The modification requests may therefore be validated (step 9). Said closing is saved in the database 15 by said history manager device 24, with the new validity end date (VED) of the main element (step 10). Said main element, that the user wished to modify, is effectively closed (step 11).

If said element was previously the subject of a constraint for another higher level closing request, said constraint is therefore resolved. All of the constraints are resolved from the lowest level towards the highest level of the hierarchy in the database.

Similarity, the main steps of the method for managing tables are identical in the case of the modification of another date existing in the database 15 or even the modification of the period of validity of an element. Likewise, in the case of the modification of the “model” during a re-allocation, the direction defined in the dated links may be modified, thus the modification of the “father” for a “son”, for example, when an existing agency formerly attached to an X centre is attached to a Y centre.

We claim:

1. A method for managing a set of data tables stored in at least one database (15), characterised in that said method comprises the steps of:
creating in at least one constructor device (11) at least one dated link with a period of validity in order to establish a relationship between at least two elements of said data tables,
creating in said constructor device (11) at least one dated rule with a period of validity in order to check the validity of said dated link,
automatically defining at least one data model by said constructor device (11) configured with at least one code according to said dated rules, including said elements of said data tables, said dated link, said dated rule, each one with a period of validity,
automatically checking in at least one data administrator device (12) the compatibility of said elements of said data tables of said data model with at least one of said dated links and one of said dated rules with the periods of validity of said data model,
after said check, automatically saving said elements of said tables of said data model by at least one history manager device (24) with said dated links and said dated rules of said data model in said database (15).

2. A method for managing data tables according to claim 1, characterised in that said dated rule comprises at least one condition to implement, separately or in combination, via said dated links, via said data tables.

3. A method for managing data tables according to claim 1, characterised in that said dated link describes at least one link with a direction defined by at least one source data table and at least one target data table in order to hierarchise said data tables.

4. A method for managing data tables according to claim 1, characterised in that the creation or the modification of at least one element of a data table automatically and successively commands the creation or the modification, separately or in combination, of at least one element of another table, of a dated link, of a dated rule, according to the hierarchical levels of the data tables.

5. A method for managing data tables according to claim 1, characterised in that a plurality of data models are created and saved by said constructor device (11) for the same data tables.

6. A method for managing data tables according to claim 1, characterised in that at least one rules manager (21) automatically checks the conformity of said dated rules according to said dated links, check centralized only in said rules manager (21).

7. A method for managing data tables according to claim 2, characterised in that at least one constraints manager (22) automatically checks the implementation of at least one condition of said dated rules according to said dated links.

8. A method for managing data tables according to claim 6, characterised in that at least one error is transmitted towards at least one user by said rules manager (21) after said checks.

9. A method for managing data tables according to claim 1, characterised in that at least one status manager (23) automatically creates a status for authorising the making available, separately or in combination, of one of said data tables, of one of said dated links, said making available is only authorised only when all of the conditions of at least one dated rule are implemented.

10. A method for managing data tables according to claim 1, characterised in that said constructor device (11) is configurable in order to automatically modify, separately or in combination, said data administrator device (12), said rights manager, said task manager, said rules manager (21), said constraints manager (22), said status manager (23), said history manager device (24).

11. A system (10) for managing a set of data tables stored in at least one database (15), characterised in that said system includes at least one constructor device (11) configured to create at least one dated link with a period of validity in order to establish a relationship between at least two elements of said data tables and configured to create at least one dated rule with a period of validity in order to check the validity of said dated link, includes at least one data administrator device (12) capable of automatically checking the compatibility of said elements of said data tables of sat least one data model with at least one of said dated links and one of said dated rules with the periods of validity of at least one data model and includes at least one history manager device (24) capable of saving after said check said elements of said data tables of said data model with the said dated links and said dated rules of said data model in said database (15).

12. A system (10) for managing data tables according to claim 11, characterised in that said data administrator device (12) is configured to command at least one status manager (23) capable of authorising the making available, separately or in combination, of one of said data tables, of one of said dated links

13. A system (10) for managing data tables according to claim 11, characterised in that said data administrator (12) device is configured to command at least one rights manager capable of checking at least one right of a user of said management system.

14. A system (10) for managing data tables according to claim 11, characterised in that said data administrator (12) device is configured to command at least one task manager capable of managing at least one modification, separately or in combination, of an element of one of said data tables, of one of said data links.

15. A system (10) for managing data tables according to claim 11, characterised in that said data administrator (12) device is configured to command at least one rules manager (21) capable of checking the conformity of said rules.

16. A system (10) for managing data tables according to claim 11, characterised in that said data administrator (12) device is configured to command at least one constraints manager (22) capable of checking the implementation of at least one condition of said rules.
